(19) United States
(12) Patent Application Publication
(10) Pub. No.: US 2016/0380557 A1
(43) Pub. Date: Dec. 29, 2016

(54) ASSEMBLY AND METHOD FOR DISCHARGING HIGH-VOLTAGE CIRCUIT OF POWER INVERTER

(71) Applicant: Hanon Systems, Daejeon (KR)

(72) Inventors: Stephan Werker, Merzenich-Golzheim (DE); Mario Lenz, Kerpen (DE); Stefan Tydecks, Koln (DE)

(21) Appl. No.: 15/193,233

(22) Filed: Jun. 27, 2016

(30) Foreign Application Priority Data
Jun. 26, 2015 (DE) 102015110285.4

(51) Int. Cl. H02M 7/5387; H02M 7/521

(52) U.S. Cl. CPC H02M 7/53871; H02M 7/521

(57) ABSTRACT

An assembly and a method for discharging a high voltage circuit of a power inverter which can automatically detect, when connection to the power inverter is interrupted, a dangerous state due to high energy accumulated in the power inverter and remove the danger as rapid as possible, and which can reduce power loss and the number of required corresponding components. The assembly includes a logic unit. The logic unit includes first input units which are coupled to a voltage sensor and a current sensor, and an output unit which outputs a discharge control signal. The output unit is coupled to an input unit of a means for triggering circuit breakers. The means for triggering the circuit breakers includes output units for outputting a driver signal. The output units are coupled to at least one of the circuit breakers of the half bridge.

### CROSS-REFERENCE TO RELATED PATENT APPLICATION

This application claims priority to German Patent Application No. 102015110285.4 filed on Jun. 26, 2015, the disclosure of which is incorporated herein by reference in its entirety.

### FIELD OF THE INVENTION

Exemplary embodiments of the present invention relate to an assembly for discharging a high-voltage circuit of a power inverter including an intermediate circuit capacitor that is disposed in such a way that a means for discharging the high-voltage circuit is indirectly coupled to an input unit of the power inverter.

Exemplary embodiments of the present invention relate to a method for discharging a high-voltage circuit of a power inverter including an intermediate circuit capacitor which is configured such that, when connection between the input unit of the power inverter and a power supply line coupled to the input unit is interrupted, the intermediate circuit capacitor is discharged.

### BACKGROUND OF THE INVENTION

Power inverters, which are also called inverters, are used to drive, for example, an electric motor, using high intermediate-circuit energy accumulated therein, along with a high voltage, particularly, in the case of vehicles, using a vehicle voltage over 60V. An example of application of the above-mentioned method is a power inverter for refrigerant compressors which is, for example, electrically operated.

While a power inverter, particularly, for vehicles, is operated, the operating state may become dangerous due to energy accumulated in a load such as a motor and/or an intermediate circuit. With regard to this, it is particularly dangerous in the case of power inverters that are operated by voltages exceeding 60V, which is within a so-called high-voltage (HV) range. Generally, electric systems that are operated by AC voltages exceeding 25V or DC voltages exceeding 60V are classified as a high-voltage system. The present invention relates to a high-voltage system having an intermediate circuit or high-voltage circuit that is operated by AC voltages exceeding 25V or DC voltages exceeding 60V, as described above.

If plugs or connectors of such power inverters are separated, electric energy that has been accumulated in the power inverters cannot be attenuated in time or safely. Thus, there is high possibility of injury of a user and/or damage to a machine.

Typically, according to conventional art, energy accumulated in an inverter can be attenuated by passive discharge resistors.

In a pure passive discharge circuit of the above-mentioned type, a resistor for discharging a high-voltage circuit of a power inverter performs discharge by attenuation of energy or voltage in such a way that current flows toward the ground potential through the resistor.

With regard to the discharge resistor having the above-described configuration, when the power inverter is normally operated, a predetermined amount of energy is always removed as a result of unnecessary power loss. Such power loss not only causes waste of energy but also makes it necessary to additionally cool the power inverter.

Another disadvantage of the passive type solutions is that discharge time, that is, time it takes to reduce an intermediate circuit voltage to a stable level in the power inverter, cannot be actively affected by the solutions. Therefore, during the operation of the power inverter, discharge time may be undesirably increased, or a lot of power loss may be required.

Due to this, particularly, when there is the need of short discharge time, the pure passive discharge circuit is not suitable because of a lot of power loss.

Solutions of attenuating electric energy through so-called active discharge circuits have been introduced. However, the active discharge circuits need corresponding triggering. Accordingly, use of additional parts, e.g., a cable, a plug, etc. or elements is required.

To discharge a high-voltage circuit, a signal generated from the outside, for example, a separate signal, a signal generated from a vehicle system through a bus command, or a so-called interlocking signal for detecting that a plug has been separated from a power supply must be provided.

However, the case where external triggering is performed through the vehicle system is disadvantageous in that when communication is interrupted (e.g., by separation of a plug, disconnection of a cable, etc.), transmission of signals is no longer possible.

An interlocking signal for detecting an error of an HV (high voltage) plug needs a special plug structure having additional interlocking contact parts. In this case, the interlocking contact parts support the interlocking signal.

Furthermore, in discharge circuits, because elements must be designed in consideration of desired power loss, additional installation space is required on a substrate.

### SUMMARY OF THE INVENTION

An object of the present invention is to provide an assembly and a method for discharging a high-voltage circuit of a power inverter which can automatically detect, when connection to the power inverter is interrupted, a dangerous state due to high energy accumulated in the power inverter and remove the danger as rapid as possible, and which can reduce power loss and the number of required corresponding components.

The above-mentioned object is solved by an assembly having characteristics as disclosed and depicted herein.

A logic unit is disposed in the power inverter. The logic unit monitors current and voltage of the high-voltage circuit of the power inverter and detects an error. To achieve this purpose, the logic unit includes corresponding input units. A current sensor which is coupled to a corresponding part of the logic unit is used for measurement of current. The voltage is monitored by measurement of current.

As the above-mentioned variables are monitored, the dangerous state of high energy accumulated in the power inverter is automatically detected by the logic unit, and a discharge control signal is generated. The logic unit is coupled to a discharge driver. The discharge driver is coupled to control input units of circuit breakers to control the circuit breakers.

In an alternative embodiment, the logic unit may be coupled to drivers disposed in the power inverter so as to control the circuit breakers.

In the assembly with the logic unit including the corresponding drivers according to the present invention, when a dangerous situation is automatically detected, the circuit breakers are turned on so that accumulated energy can be attenuated.

Furthermore, the logic unit may be coupled to circuit breakers of a plurality of half bridge through drivers or discharge drivers. In this way, when a dangerous situation is automatically detected, for example, in the case of a multiphase power inverter, the plurality of half bridges may be turned on at the same time, whereby accumulated energy can be discharged by the plurality of circuit breakers.

The discharge driver and/or logic unit is preferably coupled to first or second power supply. In this way, an operating voltage required for the operation of the unit is secured to be supplied to the logic unit and the discharge driver.

In addition, it is also preferable that an insulated gate bipolar transistor (IGTB), a transistor, a thyristor, a triac or a power MOSFET (metal-oxide-semiconductor field-effect transistor) be used as each circuit breaker.

The above object of the present invention is also solved by a method having characteristics as disclosed and depicted herein.

The method according to the present invention realizes a first method step of automatically detecting a dangerous situation due to high energy accumulated in the power inverter by continuously monitoring current (I) and voltage (U), which are parameters, in high-voltage input unit regions of the half bridge of the power inverter.

For example, after a dangerous situation caused by disconnection between the input unit of the power inverter and a high-voltage source has been detected, a discharge control signal is generated at a subsequent second method step.

Thereafter, at a third method step, the circuit breakers of the half bridge of the power inverter are controlled in such a way that accumulated energy is attenuated. To achieve this purpose, the circuit breakers are triggered by the discharge control signal at the same time and thus turned on at the same time.

Particularly, in an embodiment of the method according to the present invention, circuit breakers disposed in a plurality of half bridges may be preferably turned on at the same time by a discharge control signal so as to attenuate accumulated energy.

Preferably, the discharge control signal is formed of a plurality of switching pulses that are temporally continuous. The accumulated energy is attenuated as the circuit breakers are turned on at the same time. This way corresponds to short-circuiting of a high-voltage input unit or an intermediate circuit.

In this case, so as to prevent current from excessively increasing, the circuit breakers are triggered by the switching pulses and thus maintained in the turned-on state only for a predetermined time, and thereafter are blocked again. The process of turning on and blocking the circuit breakers is repeated by sequentially coupling a plurality of switching pulses among the switching pulses. In this way, accumulated energy is attenuated, and loads of the elements are performed within a predetermined tolerance.

In an alternative embodiment, the logic unit may generate a discharge control signal and include an additional input unit for receiving a control signal generated from the outside so as to begin to attenuate accumulated energy. As a further alternative, an input unit for an interlocking signal may be provided.

Additional details, features and advantages of the present invention will be more clearly understood from the following description of embodiments taken in conjunction with the accompanying drawings.

The present invention can automatically detect, when connection to a power inverter is interrupted, a dangerous state due to high energy accumulated in the power inverter, and remove the danger as rapid as possible, and can also reduce power loss and the number of required corresponding components.

### BRIEF DESCRIPTION OF THE DRAWINGS

FIG. 1 is a diagram showing a circuit device for an exemplary power inverter in accordance with a conventional art; and

FIG. 2 is a diagram illustrating a circuit device for a power inverter having a discharge circuit in accordance with the present invention.

### DESCRIPTION OF SPECIFIC EMBODIMENTS

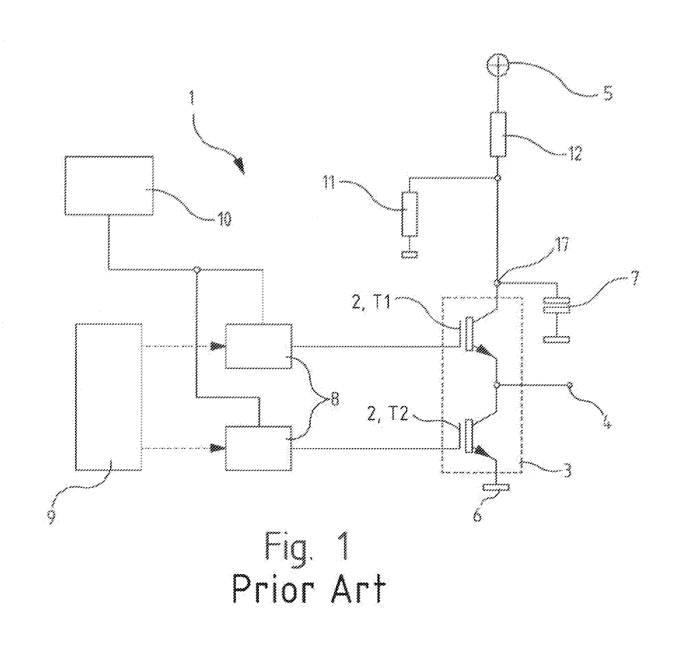

FIG. 1 is a diagram showing an exemplary power inverter 1 in accordance with a conventional art. The power inverter 1 includes two circuit breakers 2 which are indicated by T1 and T2. An output unit 4 of the power inverter 1 is disposed between the circuit breakers 2.

The circuit breaker 2 having reference character T1 is coupled to an input unit 5 to which a first operating voltage is applied. The circuit breaker 2 having reference character T2 is coupled to a reference potential 6, for example, a ground potential.

The circuit breakers 2 are coupled to drivers 8 such that they are controlled by control signals generated by the drivers 8. The circuit breakers 2 are turned on or maintained in the ON state by the control signals, whereby a voltage is applied to a first power supply of the input unit 5 of the power inverter 1, or the reference potential 6 is applied to the output unit 4 of the power inverter 1. As the control signal is suitably formed, a voltage curve in the output unit 4 can be achieved in a desired manner.

For this, the drivers 8 are triggered by a driver logic 9. For voltage supply, the drivers 8 are coupled to a second power supply 10. Alternatively, the voltage supply of the drivers 8 may be embodied by the first power supply of the input unit 5.

The power inverter 1 of FIG. 1 further includes an intermediate circuit capacitor 7. A first connection terminal of the intermediate circuit capacitor 7 is coupled to a so-called high-voltage input unit 17 of a half-bridge 3. A second connection terminal of the intermediate circuit capacitor is coupled to the reference potential/ground 6.

FIG. 1 also shows a discharge resistor 11 and a current sensor 12 which functions as a so-called shunt resistor. The shunt resistor can detect, for example, current that is received by the power inverter 1 and flows to a load. The discharge resistor 11 is used to discharge the intermediate circuit capacitor 7 of the power inverter 1 when the input unit 5 of the power inverter 1 is separated from a power supply line coupled to a high-voltage source. In this way, attenuation of energy accumulated in the intermediate circuit capacitor 7 or a load, e.g., a motor, which is electrically operated, should be secured.

In the embodiment of the power inverter 1 in accordance with the conventional art, the above-described disadvantages, that is, long discharge time and a large amount of power loss, are caused by the discharge resistor 11.

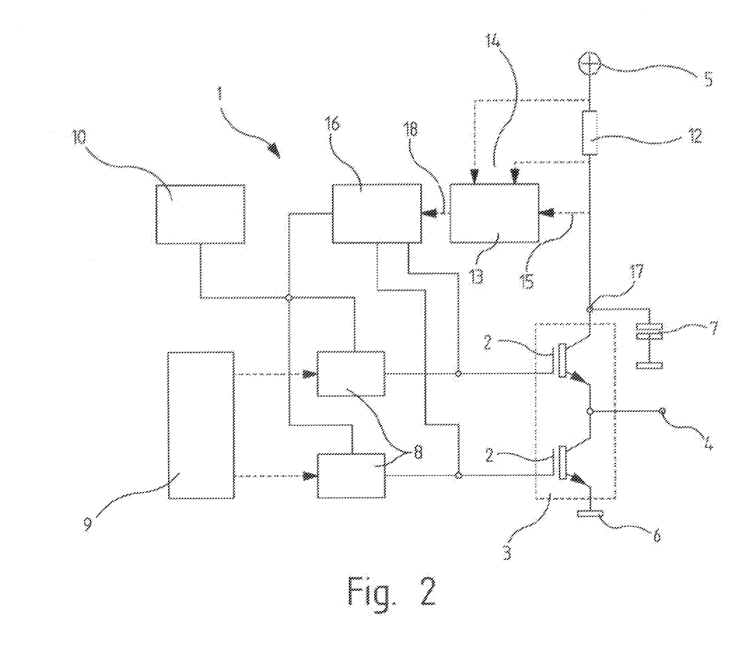

In FIG. 2, there is illustrated a power inverter 1 shown in FIG. 1 which includes two circuit breakers 2 provided in a half-bridge 3, drivers 8 that are assigned to the respective circuit breakers 2 and have a driver logic 9, a first power supply of an input unit 5, and an exemplary second power supply 10. This power inverter 1 further includes a current sensor 12 and an intermediate circuit capacitor 7.

A load which is not shown in FIG. 2 is coupled to the output unit 4 of the power inverter 1. For example, the load may be a motor for a refrigerant compressor of a vehicle.

Moreover, FIG. 2 illustrates elements of an active discharge circuit according to the present invention. The discharge circuit includes a shunt resistor which is well known as a current sensor 12 for measuring input current of the half bridge 3.

In addition, a logic unit 13 is disposed. The logic unit 13 includes first input units 14 for measuring current, and a second input unit 15 for measuring a voltage. The first input units 14 are coupled to, for example, respective connection terminals of the current sensor 12. The second input unit 15 is coupled to, for example, a node 17 of the intermediate circuit capacitor 7.

The logic unit 13 includes an output unit for outputting a discharge control signal 18. The output unit is coupled to a control input unit of a discharge driver 16 that is disposed behind the logic unit 13. The discharge driver 16 is coupled to the second power supply 10, for example, to supply a desired operating voltage. Alternatively, the discharge driver 16 may be coupled to the first power supply of the input unit 5.

The discharge driver 16 includes two output units, and these output units are coupled to respective control input units of the circuit breakers 2.

During a normal operation of the power inverter 1 for generating an output voltage of the output unit 4 for the coupled load, the circuit breakers 2 may be controlled through a driver unit 8 or individual drivers 8 by the driver logic 9.

When line connection between the input unit 5 of the power inverter 1 and a power supply line coupled to the input unit 5 is interrupted, this interruption is detected by the logic unit 13. For this, the logic unit 13 monitors current (I) using the input units 14 and monitors, using the input unit 15, a voltage (U) of a high-voltage power input unit. When the logic unit 13 detects an operating state in which a voltage (U) exceeding a regulated threshold value is present in the power inverter 1 but no current (I) is received through the high-voltage power input unit of the half bridge 3, this operating state is regarded as the case where an error has occurred. The reason for this is because of the fact that, in this case, power is supplied to the power inverter 1 itself only from energy stored in the intermediate circuit capacitor 7.

In this case, a discharge control signal 18 is provided to the output unit of the logic unit 13, whereby the discharge of the power inverter 1 is controlled.

To provide the above-mentioned discharge control signal 18, a signal generated from the outside may be used in the same manner.

In another alternative embodiment, an interlocking signal may be used for high-voltage plug-in connection.

The provided discharge control signal 18 triggers the discharge driver 16.

In the case of an error, the two circuit breakers 2 of the half bridge 3 are turned on in a short time for a regulated time or are in the ON state by the discharge driver 16. The high voltage that is present in the power inverter 1 is short-circuited or attenuated in the above-mentioned manner.

For example, in an embodiment in which the number of power inverters 1 is greater than that required by a desired output voltage or desired output phase, the discharge driver 16 may trigger a plurality of circuit breakers 2 such that the ON state is maintained.

The discharge control signal 18 provided by the logic unit 13 preferably has, for example, a plurality of rectangular wave pulses. The individual circuit breakers 2 are turned on by such pulses. In this case, a pulse duration is determined such that when the two circuit breakers 2 are turned on, a current and/or heat generation rate can be prevented from being excessively increased.

The discharge driver 16 may be formed of a simple transistor unit. In a DC voltage coupling, for example, the circuit breakers 2 may be provided through a capacitive coupling of the transistor unit of the discharge driver 16. Thereby, in terms of hardware, continuous switching on and an overload of the circuit breakers 2 of the half bridge 3 which is caused by such continuous switching on are additionally prevented.

Using a discharge control signal 18 that is alternatively provided, the drivers 8 which are operated during the normal operation may be triggered, and the circuit breakers 2 may be triggered through such driver triggering.

In a particular embodiment, to trigger the circuit breakers 2, the supply of a voltage for the logic unit 13 and the discharge driver 16, an additional switch mode controller may be embodied, and the switch mode controller is supplied with power from a high voltage to be discharged.

An advantage of the present invention is, for example, that an error pertaining to separation of power of the power inverter 1 can be autonomously detected by the internal logic unit 13 without requiring an additional external signal or interlocking signal. In this case, the detection of an error is performed regardless of whether the connection with the load is intentionally separated or a line defect is present.

Another advantage of the present invention is that the circuit breakers 2 of the half bridge 3 for voltage attenuation that are already present in any case are used. Therefore, additional elements making the circuit complex are limited to few elements that require only small space and are inexpensive.

Unlike the completely passive type solutions, additional power loss is not caused when the power inverter 1 is normally operated. Thereby, required cooling output of the power inverter 1 can be reduced, and the efficiency of the power inverter 1 can be enhanced.

Furthermore, in the case of active discharge according to the present invention, high voltage of a dangerous state can be certainly rapidly attenuated compared to that of the passive discharge.

Moreover, in the present invention, a discharge operation of the inverter can be controlled by logic as intended.

What is claimed is:

1. An assembly for discharging a high-voltage circuit of a power inverter having an intermediate circuit capacitor, the assembly comprising:
a means for discharging the high-voltage circuit indirectly coupled to an input unit of the power inverter,
a logic unit automatically detecting interruption of a connection between the input unit of the power inverter and a power supply line coupled to the input unit, wherein the logic unit includes first input units coupled to a current sensor disposed between the input unit and a high-voltage input unit of a half bridge, wherein the logic unit includes an output unit for outputting a discharge control signal, the output unit coupled to an input unit of a means for triggering circuit breakers of the half bridge,
the means for triggering the circuit breakers (2) including output units for outputting a driver signal, and wherein the output units of the means for triggering the circuit breakers are coupled to at least one of the circuit breakers of the half bridge.

2. The assembly according to claim 1, wherein the means for triggering the circuit breakers is coupled to circuit breakers of a plurality of half bridges.

3. The assembly according to claim 1, wherein the means for triggering the circuit breakers is a discharge driver or a driver.

4. The assembly according to claim 3, wherein at least one of the discharge driver and the logic unit is coupled to a second power supply or a first power supply of the input unit.

5. The assembly according to claim 1, wherein each of the circuit breakers is an insulated gate bipolar transistor, a transistor, a thyristor, or a power MOSFET (metal-oxide-semiconductor field-effect transistor).

6. A method for discharging a high-voltage circuit of a power inverter having an intermediate circuit capacitor, the method comprising the steps of:
discharging the intermediate circuit capacitor when connection between an input unit of the power inverter and a power supply line coupled to the input unit is interrupted;
automatically detecting with a logic unit the interruption of the connection between the input unit of the power inverter and the power supply line coupled to the input unit;
generating a discharge control signal when the interruption of the connection is detected; and
switching circuit breakers of a half bridge on using the discharge control signal, whereby the high-voltage circuit is discharged.

7. The method according to claim 6, wherein the circuit breakers of the half bridge are simultaneously switched on by the discharge control signal.

8. The method according to claim 6, wherein a plurality of circuit breakers of a plurality of half bridges are switched on by the discharge control signal.

9. The method according to claim 6, wherein the discharge control signal is formed by a plurality of switching pulses that are temporally continuous to switch the circuit breakers of the half bridge on.
